(19) United States
(12) Patent Application Publication
(10) Pub. No.: US 2006/0016648 A1
(43) Pub. Date: Jan. 26, 2006

(54) Shock absorber of a seat of a wheelchair

(76) Inventor: Samuel Lin, Chia Yi City (TW)

Correspondence Address: MORTON J. ROSENBERG;ROSENBERG, KLEIN & LEE, SUITE 101, 3458 ELLICOTT CENTER DRIVE, ELLICOTT CITY, MD, 21043, US

(21) Appl. No.: 11/209,829

(22) Filed: Aug. 24, 2005

Related U.S. Application Data
(62) Division of application No. 10/894,000, filed on Jul. 20, 2004.

(51) Int. Cl. F16D 57/00

(52) U.S. Cl. 188/266

(57) ABSTRACT

A shock absorber is provided to a seat of a wheelchair, which includes an outer tube secured on an upper side of a frame of the wheelchair, an inner tube secured on a bottom of the seat and movably passed into the outer tube, and a spring-loaded shock absorbing mechanism; the outer tube is formed with a pair of opposing radial through holes on an upper end portion thereof; the inner tube is formed with two opposing lengthwise extending slots, and is prevented from separating from the outer tube with help of a pin, which is passed through the radial holes as well as the slots; the shock absorbing mechanism is held in the outer tube and connected to the outer tube, and a lower end of the inner tube at lower and upper ends respectively.

### BACKGROUND OF THE INVENTION

1. Field of the Invention

The present invention relates to a shock absorber of a seat of a wheelchair, which can reduce violent shaking of the seat effectively for the wheelchair to be comfortable to ride on.

2. Brief Description of the Prior Art

Conventional wheelchairs for people to ride on are usually only equipped with shock absorbers between the wheels and the frame, but are not equipped with shock absorbers for the seats. Therefore, violent shaking of one such conventional wheelchair can't be effectively reduced, and a person ridding on the wheelchair will still feel uncomfortable when the wheelchair is shaking violently.

### SUMMARY OF THE INVENTION

It is a main object of the present invention to provide a shock absorber of a seat of a wheelchair such that violent shaking of the seat can be effectively reduced.

The shock absorber of the present invention includes an outer tube secured on an upper side of a frame of the wheelchair, an inner tube secured on a bottom of the seat and movably passed into the outer tube, and a spring-loaded shock absorbing mechanism. The outer tube is formed with a pair of opposing radial holes on an upper end portion. The inner tube is formed with two opposing lengthwise extending slots, and is prevented from separating from the outer tube with help of a pin, which is passed through the radial holes as well as the slots; the shock absorbing mechanism is held in the outer tube and connected to the outer tube, and a lower end of the inner tube at lower and upper ends thereof respectively.

### BRIEF DESCRIPTION OF THE DRAWINGS

The present invention will be better understood by referring to the accompanying drawings, wherein:

FIG. 1 is a perspective view of the wheelchair according to the present invention,

FIG. 2 is an exploded perspective view of the present invention,

FIG. 3 is a vertical sectional view of the present invention, and

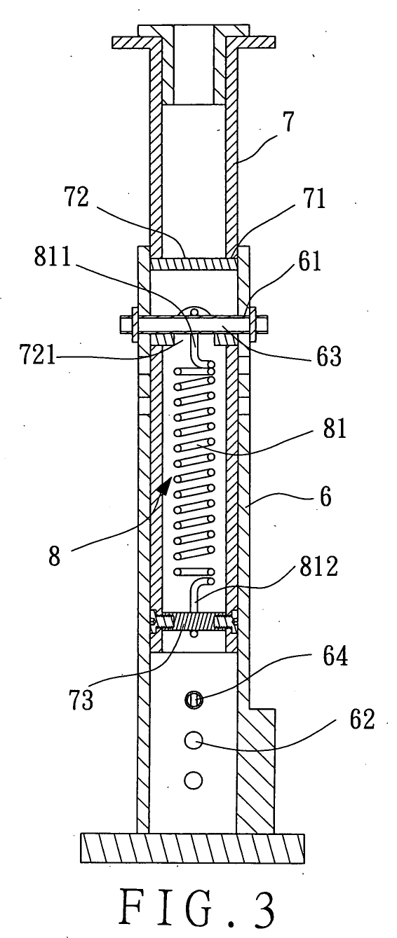

FIG. 4 is a vertical sectional view of the present invention.

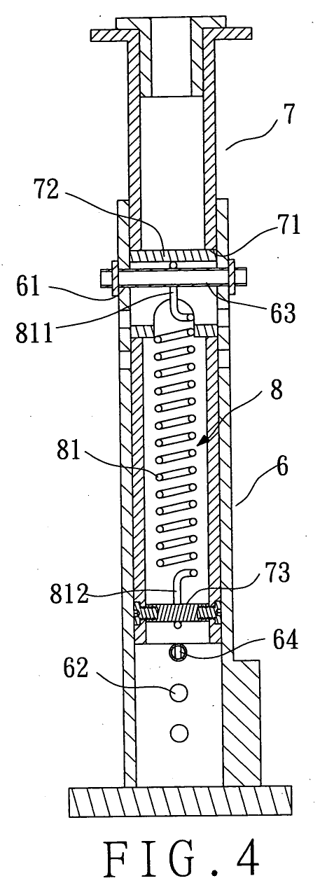

### DETAILED DESCRIPTION OF THE PREFERRED EMBODIMENTS

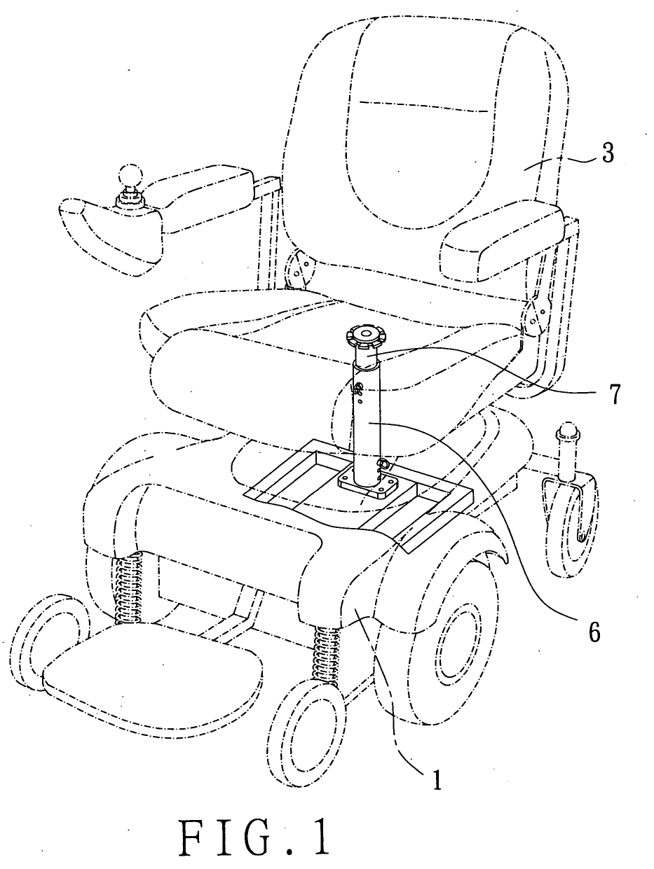

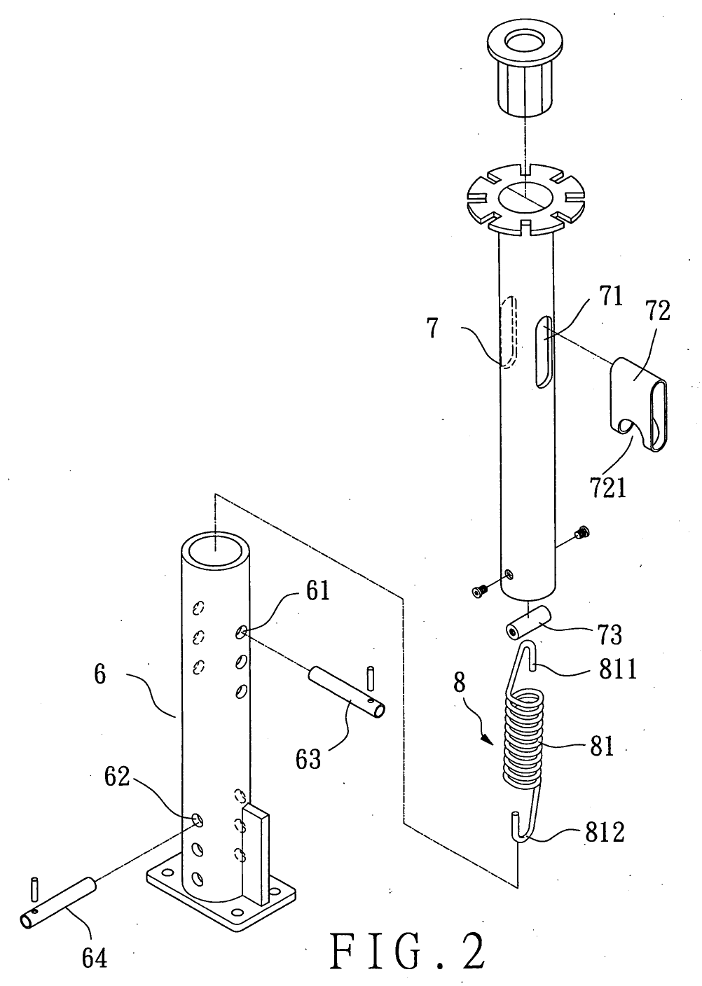

Referring to FIGS. 1 and 2, a preferred embodiment of a shock absorber of a seat 3 of a wheelchair includes an outer tube 6, a shock absorbing mechanism 8, and an inner tube 7.

The outer tube 6 is formed with several pairs of opposing radial through holes 61 along an upper end portion, and several pairs of opposing radial through holes 62 along a lower end portion thereof; the distance between every two adjacent upper holes 61 is the same as the distance between every two adjacent lower holes 62. A pin 64 is tightly passed through a selected pair of lower through holes 62.

The inner tube 7 is formed with two lengthwise extending slots 71, which are right faced with each other. A strengthening element 72 is tightly fitted in the slots 71, which has a through hole having the same shape as the slots 71, and a gap 721 at a bottom side thereof. The inner tube 7 is up and down movably passed into the outer tube 6, and a pin 63 is passed through the through hole of the strengthening element 72 and a selected pair of upper through holes 61; thus, the inner tube 7 can't separate from the outer tube 6, and it can only be displaced relative to the outer tube 6 within a certain range. And, the pin 64 at the lower portion of the outer tube 6 will stop the inner tube 7 to prevent the same from moving further down.

The shock absorbing mechanism 8 includes an elastic element 81, which is passed through the gap 721 of the strengthening element 72, and hooked over the pin 63 at a first end 811 thereof. In addition, a locating pin 73 is secured on a lower end of the inner tube 7, and the elastic element 81 is hooked over the locating pin 73 at a second end 812 thereof.

Thus, when the seat 3 of the wheelchair moves upwards and downwards during shaking of the wheelchair, the elastic element 81 will counteract movement of the seat 3. Consequently, the wheelchair will be more comfortable to ride on.

From the above description, it can be easily understood that the shock absorber of the present invention can reduce violent shaking of the seat effectively when one is ridding on the wheelchair.

What is claimed is:

1. A shock absorber of a seat of a wheelchair, comprising
a shock absorbing mechanism; the shock absorbing mechanism being held in an inner tube, which is secured on a bottom of a seat of a wheelchair at an upper end thereof; the inner tube being formed with two lengthwise extending slots faced with each other; the inner tube having a first pin disposed in a lower end thereof;
the inner tube being passed into, and linearly displaceable relative to an outer tube, which is secured on an upper side of a frame of the wheelchair at a lower end thereof; the outer tube being formed with a first pair of opposing radial through holes on an upper end portion thereof;
the inner tube being prevented from separating from the outer tube with help of a second pin, which is passed through the opposing radial through holes of the outer tube as well as the lengthwise extending slots of the inner tube;
the shock absorbing mechanism being connected to the first and the second pins respectively at two ends thereof for reducing shaking of the seat.

2. The shock absorber of a seat of a wheelchair as claimed in claim 1, wherein a strengthening element, which has a through hole similar to the slots of the inner tube in shape, is tightly fitted in the slots of the inner tube, and the second pin is passed through the strengthening element; the strengthening element having a gap on a lower end, through which the shock absorbing mechanism is passed.

3. The shock absorber of a seat of a wheelchair as claimed in claim 2, wherein the shock absorbing mechanism is an elastic element.

4. The shock absorber of a seat of a wheelchair as claimed in claim 2, wherein the outer tube is formed with a pair of opposing radial through holes on a lower end portion thereof, and a third pin is passed through the radial through holes such that the inner tube is prevented from moving below the third pin.

5. The shock absorber of a seat of a wheelchair as claimed in claim 4, wherein the shock absorbing mechanism is an elastic element.

6. The shock absorber of a seat of a wheelchair as claimed in claim 1, wherein the outer tube is formed with plural pairs of opposing radial through holes along the upper end portion thereof in addition to the first pair for allowing the second pin to be selectively connected thereto, thus allowing the seat to be adjusted in height by means of relocating the second pin.

7. The shock absorber of a seat of a wheelchair as claimed in claim 6, wherein the shock absorbing mechanism is an elastic element.

8. The shock absorber of a seat of a wheelchair as claimed in claim 6, wherein a strengthening element, which has a through hole similar to the slots of the inner tube in shape, is tightly fitted in the slots, and the second pin is passed through the strengthening element; the strengthening element having a gap on a lower end, through which the shock absorbing mechanism is passed.

9. The shock absorber of a seat of a wheelchair as claimed in claim 8, wherein the shock absorbing mechanism is an elastic element.

10. The shock absorber of a seat of a wheelchair as claimed in claim 6, wherein the outer tube is formed with a pair of opposing radial through holes on a lower end portion thereof, and a third pin is passed through the radial through holes such that the inner tube is prevented from moving below the third pin.

11. The shock absorber of a seat of a wheelchair as claimed in claim 10, wherein the shock absorbing mechanism is an elastic element.

12. The shock absorber of a seat of a wheelchair as claimed in claim 1, wherein the outer tube is formed with a pair of opposing radial through holes on a lower end portion thereof, and a third pin is passed through the radial through holes such that the inner tube is prevented from moving below the third pin.

13. The shock absorber of a seat of a wheelchair as claimed in claim 12, wherein the shock absorbing mechanism is an elastic element.

14. The shock absorber of a seat of a wheelchair as claimed in claim 1, wherein the shock absorbing mechanism is an elastic element.
